(19) United States
(12) Patent Application Publication
(10) Pub. No.: US 2026/0029191 A1
(43) Pub. Date: Jan. 29, 2026

(54) CONSUMER APPLIANCE DISPLAY PANELS AND METHODS OF LOW-POWER OPERATION

(71) Applicant: Haier US Appliance Solutions, Inc., Wilmington, DE (US)

(72) Inventors: Timothy Ray Jackson, Louisville, KY (US); Brian Keith Owens, Lexington, KY (US); Zachary Tencza, Louisville, KY (US)

(21) Appl. No.: 18/787,105

(22) Filed: Jul. 29, 2024

(51) Int. Cl. F25D 29/00; F25D 23/02; F25D 27/00

(52) U.S. Cl. CPC F25D 29/005; F25D 23/028; F25D 27/005; F25D 2400/36

(57) ABSTRACT

An appliance user interface panel, or method of operation, may include a liquid crystal (LCD) panel and a controller. The LCD panel may be mounted on a body panel of a consumer appliance. The LCD panel may include a panel set of light sources. The controller may be operably coupled to the panel set. The controller may be configured to initiate a display operation. The display operation may include directing illumination of a static image region of the LCD panel at an operational brightness level, detecting a low-power condition, and directing deviated illumination of the static image region at a reduced brightness level for a low-power state based on the detected low-power condition.

### FIELD OF THE DISCLOSURE

The present subject matter relates generally to user interfaces for consumer appliances, such as refrigerator appliances, and methods for low-power operation of a display panel.

### BACKGROUND OF THE DISCLOSURE

Consumer appliances, such as refrigerators, ovens, microwaves, dishwashers, etc., often utilize a dynamic display panel (e.g., liquid crystal display (LCD) panel) to provide feedback or information related to an appliance's operation. Generally, one or more light sources or backlights are provided to illuminate the display panel. For clarity and visibility, such display panels typically try to maintain uniform illumination across the entirety of the screen or viewing area of the display panel.

Although dynamic display panels are often useful and visually appealing, they can consume relatively high amounts of power or electricity. This may, in turn, increase an appliance's overall power consumption and reduce its efficiency. Attempts have been made to mitigate power consumption of a dynamic display panel, such as by temporarily deactivating the panel or uniformly reducing illumination. For instance, it is common for appliances to dim the entirety of the screen or viewing area following a period of prolonged inactivity or lack of user engagement. Oftentimes, this is done while projecting a static image over at least a portion of the screen or viewing area (e.g., alone or in conjunction with a dynamic image, such as a clock display, that changes over time). However, this may result in an image that is nearly illegible and visually unappealing or a power draw that is still significant, thereby risking frustration to a user or an unacceptably high level of power consumption.

As a result, it would be useful to provide a consumer appliance or user interface addressing one or more of the above issues.

### BRIEF DESCRIPTION OF THE DISCLOSURE

Aspects and advantages of the invention will be set forth in part in the following description, or may be obvious from the description, or may be learned through practice of the invention.

In one exemplary aspect of the present disclosure, a method of operating a user interface of a consumer appliance is provided. The method may include directing illumination of a static image region of an LCD panel at an operational brightness level. The method may also include detecting a low-power condition. The method may further include directing deviated illumination of the static image region at a reduced brightness level for a low-power state based on the detected low-power condition.

In another exemplary aspect of the present disclosure, an appliance user interface panel is provided. The appliance user interface panel may include a liquid crystal (LCD) panel and a controller. The LCD panel may be mounted on a body panel of a consumer appliance. The LCD panel may include a panel set of light sources. The controller may be operably coupled to the panel set. The controller may be configured to initiate a display operation. The display operation may include directing illumination of a static image region of the LCD panel at an operational brightness level, detecting a low-power condition, and directing deviated illumination of the static image region at a reduced brightness level for a low-power state based on the detected low-power condition.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front elevation view of a refrigerator appliance according to exemplary embodiments of the present disclosure.

FIG. 2 provides a front elevation view of a refrigerator appliance according to exemplary embodiments of the present disclosure, wherein refrigerator doors are shown in an open position.

FIG. 3 provides a schematic view of a refrigerator appliance according to exemplary embodiments of the present disclosure.

FIG. 4 provides a simplified sectional view of a portion of the user interface of a consumer appliance according to exemplary embodiments of the present disclosure.

FIG. 5 provides a plan view of a portion of a user interface of a consumer appliance according to exemplary embodiments of the present disclosure, wherein the panel is illuminated uniformly at an operational brightness level.

FIG. 6 provides a plan view of the exemplary user interface of FIG. 5, wherein the panel is illuminated non-uniformly at a reduced brightness level.

FIG. 7 provides a schematic view of a portion of a user interface of a consumer appliance according to exemplary embodiments of the present disclosure.

FIGS. 8A, 8B, and 8C provide plan views of the exemplary user interface of FIG. 5, wherein the panel is illuminated non-uniformly at a reduced brightness level and a varied activation of the light sources is illustrated across the three views.

FIG. 9 provides a flow chart illustrating a method of operating a user interface of a consumer appliance according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents. The word “exemplary” is used herein to mean “serving as an example, instance, or illustration.” In addition, reference to “an embodiment” or “one embodiment” does not necessarily refer to the same embodiment, although it may. Any implementation described herein as “exemplary” or “an embodiment” is not necessarily to be construed as preferred or advantageous over other implementations.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Aspects of the present disclosure may generally provide a consumer appliance or display panel having an increased efficiency operational efficiency or a significantly lower power draw (e.g., in comparison to existing appliances or display panels) over the life thereof. Notably, such improvements may be realized without impairing overall visibility or usability. Additionally or alternatively, information regarding the status of the appliance may be communicated effectively (e.g., with greater speed or efficacy than is realized with existing appliances or display panels).

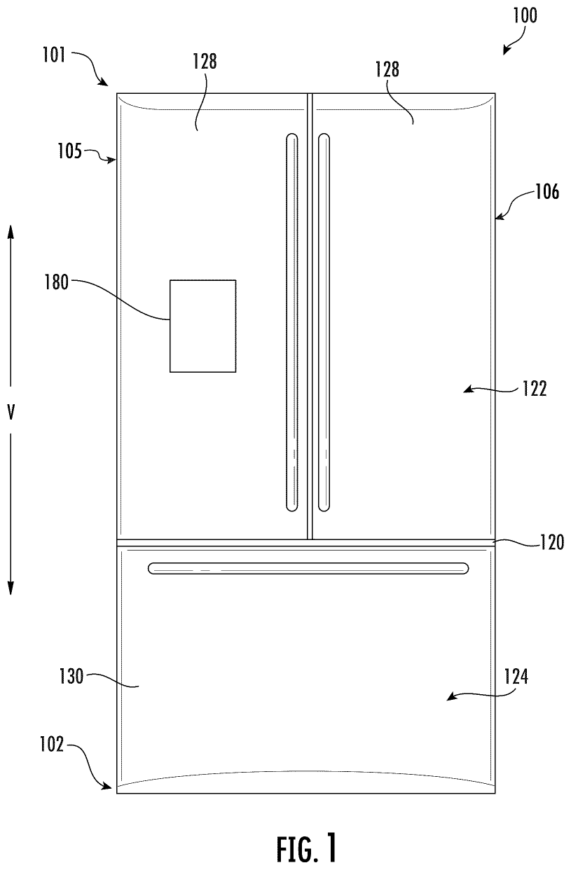

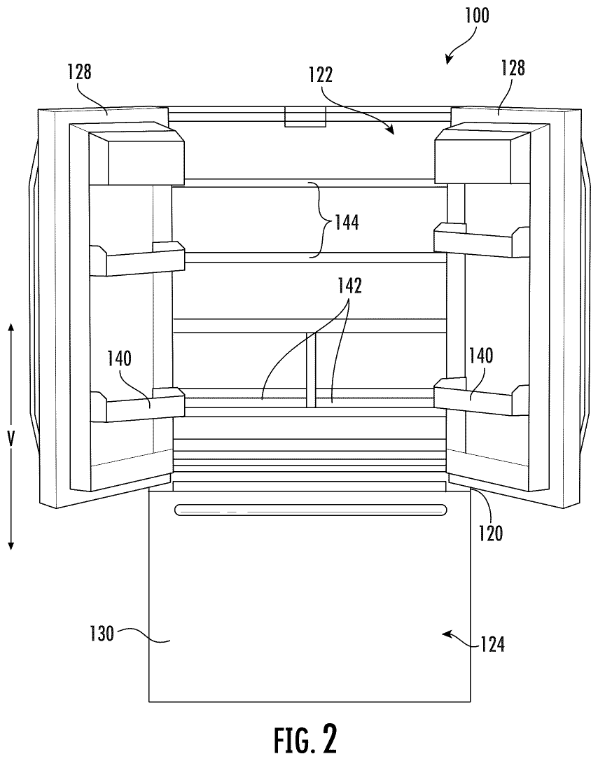

Turning now to the figures, FIG. 1 illustrates a consumer appliance 100 according to exemplary embodiments of the present disclosure. Specifically, FIG. 1 provides a front elevation view of a refrigerator appliance 100 according to exemplary embodiments of the present disclosure with refrigerator doors 128 of the refrigerator appliance 100 shown in a closed position. FIG. 2 provides a front view elevation of refrigerator appliance 100 with refrigerator doors 128 shown in an open position to reveal a fresh food chamber 122 of refrigerator appliance 100.

Generally, consumer appliance 100 includes a cabinet 120 on which one or more communications features (e.g., a control panel or display 180) are mounted. In the exemplary embodiments of FIG. 1, consumer appliance is provided as a refrigerator appliance 100. However, as would be understood, consumer appliance 100 may be provided as any suitable consumer appliance (e.g., a microwave, oven, cooktop, range, dishwasher, washing machine, dryer, etc.), except as otherwise indicated.

As generally illustrated in FIG. 1, refrigerator appliance 100 includes a housing or cabinet 120 that defines chilled chambers for receipt of food items for storage. In particular, cabinet 120 defines a fresh food chamber 122 positioned at or adjacent to the top of cabinet 120 and a freezer chamber 124 arranged at or adjacent the bottom of cabinet 120. As such, refrigerator appliance 100 is generally referred to as a bottom mount refrigerator. It is recognized, however, any other suitable appliance or refrigerator style, such as, for example, a top mount refrigerator appliance, a side-by-side style refrigerator appliance, etc. may be provided. Consequently, the description set forth herein is for illustrative purposes only and is not intended to be limiting in any aspect to any particular refrigerator chamber configuration or, as noted above, any particular style of appliance.

Refrigerator appliance 100 includes a housing or cabinet 120 that extends between a top 101 and a bottom 102 along a vertical direction V. Cabinet 120 also extends along a lateral direction L between a first lateral side 105 and a second lateral side 106, as well as along a transverse direction T between a front end and a rear end. Each of the vertical direction V, lateral direction L, and transverse direction T are mutually perpendicular to one another to define an orthogonal directional system.

Cabinet 120 defines chilled chambers for receipt of food items for storage. In the illustrated embodiments, cabinet 120 defines fresh food chamber 122 positioned at or adjacent top 101 of cabinet 120 and a freezer chamber 124 arranged at or adjacent bottom 102 of cabinet 120. As such, refrigerator appliance 100 is generally referred to as a bottom mount refrigerator. As noted above, however, the present disclosure is not limited to any particular arrangement or appliance, that the benefits of the present disclosure apply to other types and styles of refrigerator appliance, except as otherwise indicated.

Refrigerator doors 128 are rotatably hinged to an edge of housing 120 for selectively accessing fresh food chamber 122. In addition, a freezer door 130 is arranged below refrigerator doors 128 for selectively accessing freezer chamber 124. Freezer door 130 is coupled to a freezer drawer 142 (not shown) slidably mounted within freezer chamber 124. As discussed above, refrigerator doors 128 and freezer door 130 are shown in the closed configuration in FIG. 1, and refrigerator doors 128 are shown in the open position in FIG. 2.

In the exemplary embodiments of FIGS. 1 and 2, the refrigerator doors 128 are provided in a French door 128 arrangement. Thus, doors 128 may include a pair of independently movable doors 128 (i.e., door 128 segments) pivoted at opposite lateral sides of the cabinet 120. In other words, a first door 128 is pivotably mounted to first lateral side 105 while a second door 128 is pivotably mounted to second lateral side 106 to move or pivot independently from the first door 128.

Turning now to FIG. 2, various storage components are mounted within fresh food chamber 122 to facilitate storage of food items therein as will be understood by those skilled in the art. In particular, the storage components include bins 140, drawers 142, and shelves 144 that are mounted within fresh food chamber 122. Bins 140, drawers 142, and shelves 144 are configured for receipt of stored items (e.g., beverages or solid food items) and may assist with organizing such food items. As an example, drawers 142 can receive fresh food items (e.g., vegetables, fruits, or cheeses) and increase the useful life of such fresh food items.

Refrigerator appliance 100 also includes features for assisting a user with identifying food items positioned within fresh food chamber 122 or freezer chamber 124. The user can utilize such features, for example, to view food items stored within fresh food chamber 122 or freezer chamber 124 or create an inventory of such food items. Such features are discussed in greater detail below.

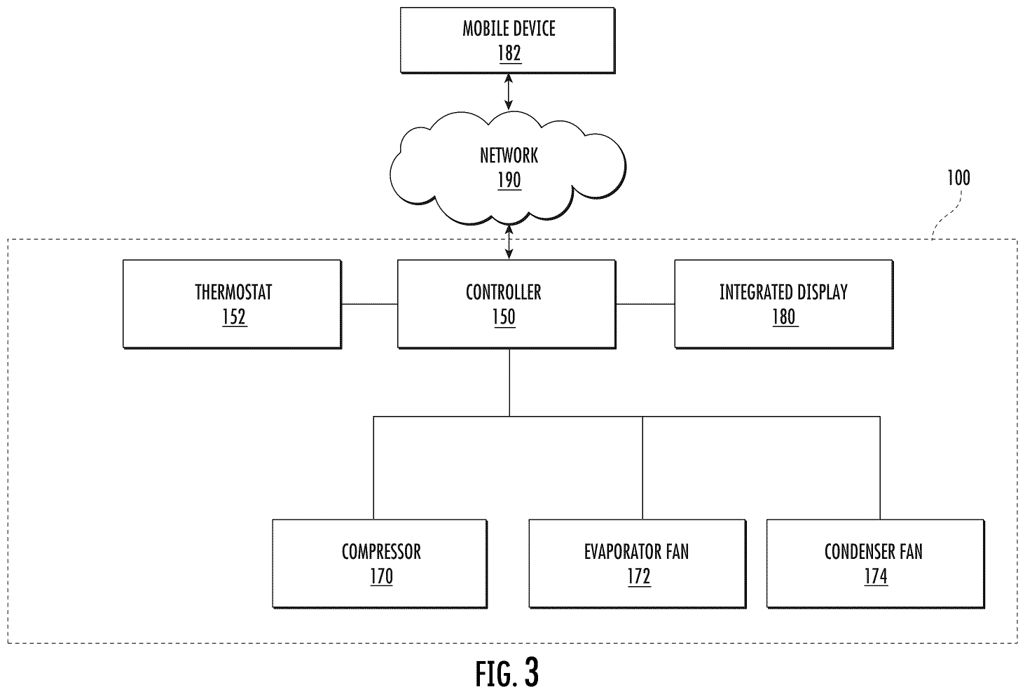

FIG. 3 provides a schematic view of refrigerator appliance 100. Refrigerator appliance 100 includes a controller 150 that is operatively coupled or in communication with components of a refrigeration system (not shown) of refrigerator appliance 100 configured for cooling fresh food chamber 122 or freezer chamber 124. The components include a compressor 170, an evaporator fan 172, and a condenser fan 174. Controller 150 can selectively operate such components in order to cool fresh food chamber 122 or freezer chamber 124. Controller 150 is also in communication with a thermostat (e.g., a thermocouple or thermistor). The thermostat may be positioned in fresh food compartment 122 or freezer compartment 124 (FIG. 2). Controller 150 may receive a signal from the thermostat that corresponds to a temperature of fresh food compartment 122 or freezer compartment 124. Controller 150 may also include an internal timer for calculating elapsed time periods.

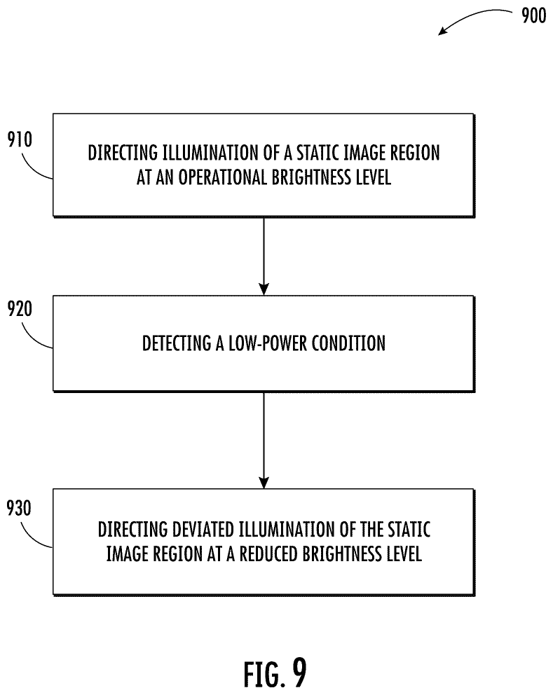

Controller 150 may include a memory and one or more microprocessors, CPUs, or the like, such as general or special purpose microprocessors operable to execute programming instructions or micro-control code associated with operation of refrigerator appliance 100. The memory may represent random access memory such as DRAM, or read only memory such as ROM or FLASH. In some embodiments, the processor executes non-transitory programming instructions stored in memory. For certain embodiments, the instructions include a software package configured to operate appliance 100 or execute an operation routine (e.g., the exemplary method 900 described below with reference to FIG. 9). The memory may be a separate component from the processor or may be included onboard within the processor. Alternatively, controller 150 may be constructed without using a microprocessor (e.g., using a combination of discrete analog or digital logic circuitry; such as switches, amplifiers, integrators, comparators, flip-flops, AND gates, and the like) to perform control functionality instead of relying upon software.

Controller 150 may be positioned in a variety of locations throughout refrigerator appliance 100. Input/output (“I/O”) signals may be routed between controller 150 and various operational components of refrigerator appliance 100. One or more components of refrigerator appliance 100 may be in operative communication (e.g., electric communication) with controller 150 via one or more conductive signal lines or shared communication busses. Additionally or alternatively, one or more components of refrigerator appliance 100 may be in operative communication (e.g., wireless communication) with controller 150 via one or more wireless signal bands.

In certain embodiments, refrigerator appliance 100 includes an integrated display 180 (e.g., dynamic display panel), as will be described in greater detail below. Generally, integrated display 180 may be mounted on refrigerator door 128 (FIG. 1) or at any other suitable location on refrigerator appliance 100. Integrated display 180 is in operative communication with controller 150 such that integrated display 180 may receive a signal from controller 150 corresponding to one or more images, messages, icons, etc. to be presented on the display 180.

In some such embodiments, refrigerator appliance 100 (e.g., controller 150) is in communication with a mobile device 182 via network 190. Mobile device 182 can be any device configured to communicate over network 190. For example, mobile device 182 may be a computer, a smartphone, or a tablet. Mobile device 182 is in communication with controller 150 such that mobile device 182 may receive a signal from controller 150 (via network 190). Mobile device 182 can receive such signal from controller 150 and present one or more images to a user visually. Mobile device 182 may include, for example, a liquid crystal display panel (LCD), a plasma display panel (PDP), or any other suitable mechanism for displaying an image (e.g., a projector). Mobile device 182 can also include an interface (e.g., tactile inputs, such as buttons, or a graphical user interface) that allows mobile device 182 to initiate communications with refrigerator appliance 100 over network 190.

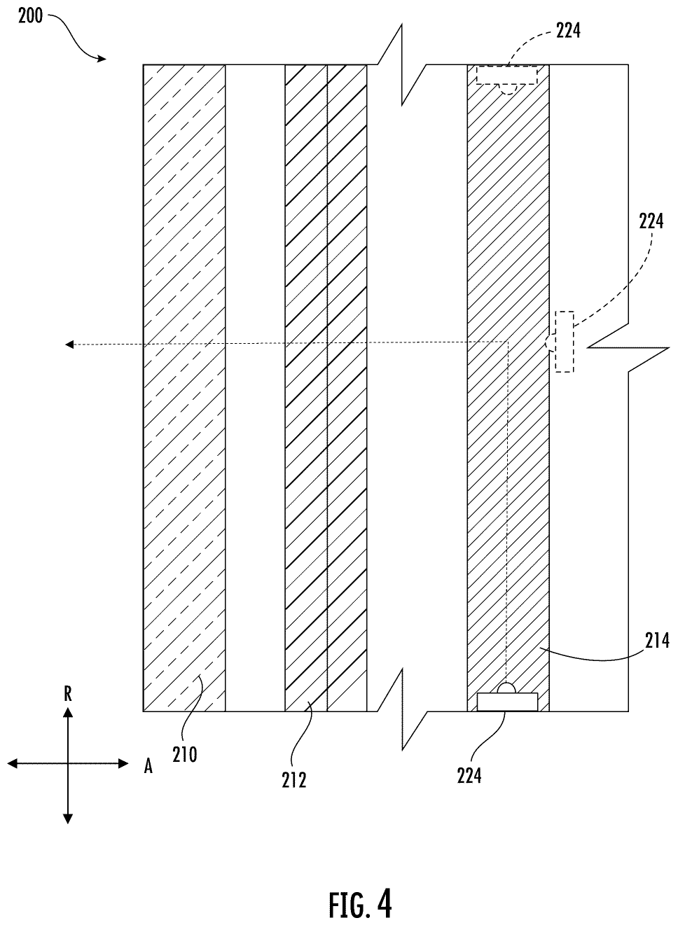

Turning now to FIG. 4, a sectional view is provided of a portion of a user interface 200 (e.g., provided as or as part of panel 180-FIG. 1) according to exemplary embodiments of the present disclosure. As shown, user interface 200 generally defines an axial direction A extending from a front end of user interface 200 to a back end of a user interface 200. For example, the front end may be disposed at a touch surface of appliance 100 (e.g., to receive a user's touch or input) while the back end is disposed within the door 128 or cabinet 120 (e.g., and is generally inaccessible to a user during operation of appliance 100). In addition to the axial direction A, user interface 200 generally defines a radial direction R perpendicular to the axial direction A.

Generally, user interface 200 includes or is provided as a liquid crystal display (LCD) panel having multiple layers or panels. For instance, an external panel 210, liquid crystal panel 212, and light unit 214 may all be stacked together along the axial direction A. As would be understood, one or more mechanical fasteners (e.g., bolts, nuts, brackets, etc.), adhesives, solders, or combinations thereof may join the stacked layers together or otherwise hold the same in a fixed position relative to each other. As shown, at least a portion of external panel 210, liquid crystal panel 212, and light unit 214 may each be aligned with each other along the axial direction A and radial direction R. When assembled, liquid crystal panel 212 and light unit 214 are provided in communication (e.g., electrical or wireless communication) with or as part of controller 150.

It is noted that, as would be understood, user interface 200 may be provided as a passive output device (e.g., for display only) or as an active-engagement device (e.g., touchscreen) capable of receiving direct user input as well as displaying an informational output.

As would be understood, at least a portion of external panel 210 is formed from one or more suitable dielectric, transparent, and solid or nonpermeable materials, such as a plastic material (e.g., acrylic, polycarbonate, etc.) or ceramic material (e.g., glass or glass-ceramic) to cover and protect the liquid display panel 212. Liquid display panel 212 itself can include multiple sub-layers for the dynamic display of one or more images, such as one or more polarizing films, filters, electrodes, or liquid crystal layers; which are generally understood.

Rearward from the liquid display panel 212 is a light unit 214. The light unit 214 generally includes one or more light sources 224 directed (e.g., directly or indirectly) at the liquid display panel 212 and external panel 210. Each light source 224 may be provided as any suitable electrical light source 224, such as a light-emitting diode (LED), fluorescent bulb, halogen bulb, etc. Such light sources 224 may be, for instance, mounted on printed circuit board (“PCB”) onto which one or more electrical components and electrical circuit paths may be provided. Multiple light sources 224 may be provided as part of a panel set 222 (FIG. 5). Optionally, a translucent light diffusional panel may be provided to guide or disperse light emissions from the light sources 224. When assembled, the light sources 224 may generally be provided at any suitable location rearward from liquid display panel 212. For instance, as would be understood, one or more light sources 224 may be positioned below, above, or laterally outward from a visible region 230 of the external panel 210 (e.g., while being directed radially inward or toward the outer edges of a light diffusion panel 228). Additionally or alternatively, one or more light sources 224 may be directly rearward or in axial alignment with a visible region 230 of the external panel 210 (e.g., as a matrix of multiple discrete light sources 224).

Activation or illumination of light source 224 may be generally controlled by controller 150 (FIG. 3), such as according to one or more active menu branches or option sets (e.g., to indicate a user input, state of the appliance, settings of the appliance, or any other relevant information to a user). As will be described in greater detail below, individual light sources 224 may be controlled independently or as part of sub-sets of the total number of light sources 224 in the panel set 222.

Turning now generally to FIGS. 5 through 8C, various views are provided of a user interface 200, including a visible region 230 on which one or more images may be projected and selectively illuminated by a panel set 222 having a plurality of light sources 224. As shown, a static image region 232 may be presented across at least a portion of the visible region 230 of the interface 200. For instance, the static image region 232 may be provided a non-black background image over which one or more engageable icons or dynamic regions (e.g., a calendar or clock display) may be presented. Although various particular images and icons are shown, the present disclosure is generally applicable to any arrangement or format of image, text, or symbols that can be presented or displayed.

Turning especially to FIG. 5, during certain states or operations (e.g., such as when a user is present or directly engaging with the appliance 100—FIG. 1), user interface 200 may be provided in an engagement state. The static image region 232 may be illuminated at an operational brightness level—e.g., a first brightness level corresponding to a predetermined brightness setting (e.g., in nits or lumens), voltage output, duty cycle, or number of total active light sources 224. Moreover, the static image region 232 may be illuminated substantially uniformly (i.e., in a uniform illumination condition). In turn, the user may be unable to visually perceive a reduced or increased brightness (e.g., “hot spot”) at any portion of the visible region 230 or static image region 232. In some such embodiments, the illumination or brightness level across the entirety of the visible region 230 or static image region 232 may be substantially equal for each square meter viewable on visible region 230 or external panel 210 (FIG. 4). Optionally, each light source 224 of the panel set 222 may be active as part of an operation number of light sources 224 (e.g., LEDs) of the panel set 222. Additionally or alternatively, an operational number less than the entirety of the panel set 222 may be active (e.g., to emit light therefrom) according to a uniform pattern—e.g., such that an equivalent brightness level is presented or measurable across a plurality of equal (e.g., in visible surface area) sub-portions of the visible region 230 or static image region 232. In the illustrated embodiments of FIG. 5, three discrete sub-portions are provided as laterally adjacent strips. Nonetheless, any suitable number (e.g., between two and 50) of sub-portions may be defined.

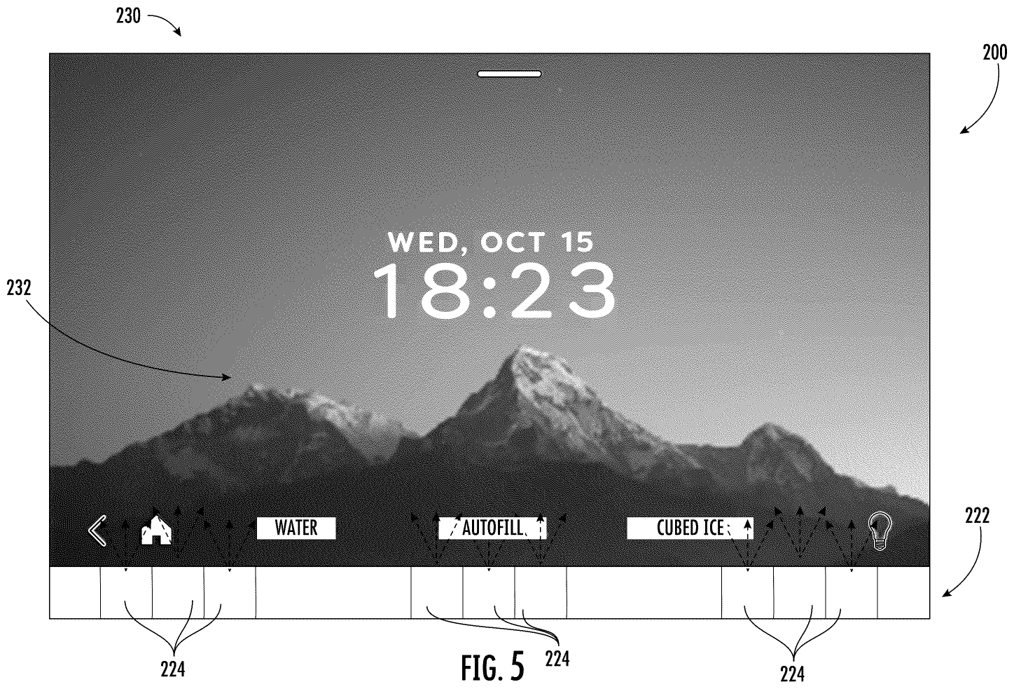

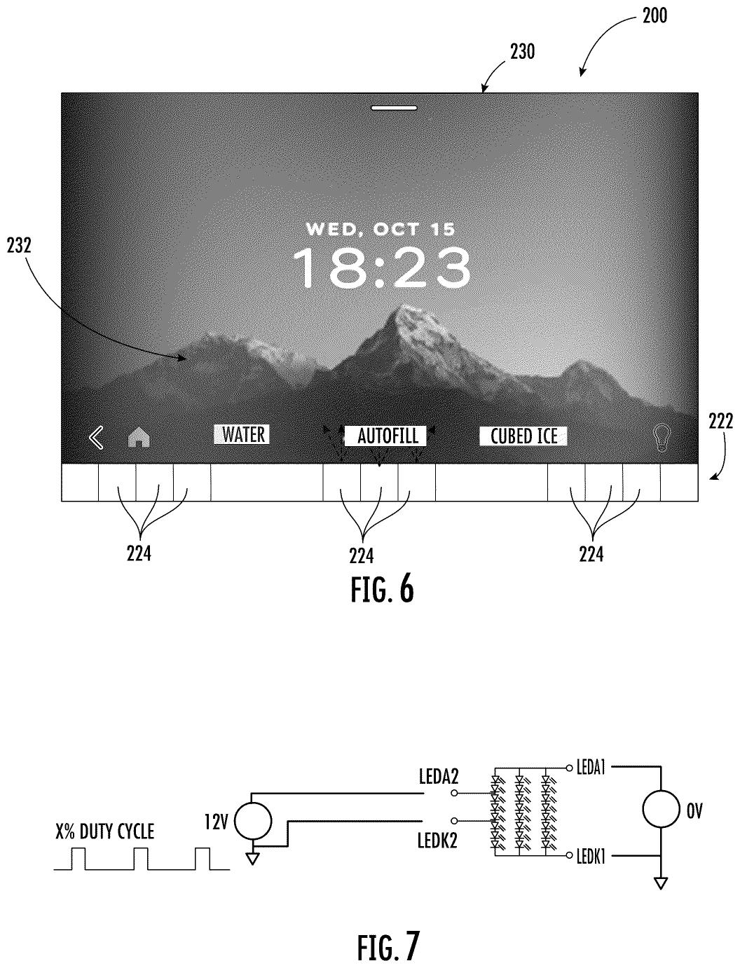

Turning especially to FIG. 6, during certain other states or operations (e.g., such as when a user has selected a low-power option or has failed to engage with the appliance 100—FIG. 1—for an extended period of time), user interface 200 may be provided in a low-power state. The static image region 232 may be illuminated at a reduced brightness level—e.g., a second brightness level corresponding to a predetermined brightness setting (e.g., in nits or lumens), voltage output, duty cycle, or number of total active light sources 224 that is less than the operational brightness level. Moreover, the static image region 232 may be illuminated non-uniformly (i.e., in a deviated illumination condition). In turn, the user may visually perceive that one portion of the visible region 230 or static image region 232 is dimmer than another portion. In some such embodiments, the number of active light sources 224 may be less than the total number of light sources 224 in the panel set 222. For instance, a reduced number of light sources 224 (e.g., LEDs) of the total panel set 222, which is less than the operational number of light sources 224 (e.g., LEDs), may be active or directed to emit light therefrom. The number of active light sources 224 may be selected according to a predetermined deviated pattern (e.g., such that an odd number of light sources 224 or sub-portions are illuminated). Additionally or alternatively, the brightness or power output of each active light source 224 may be reduced (e.g., in comparison to the active-engagement or wake state). Thus, the power or voltage directed to an individual active light source 224 in the low-power state may be less than the power or voltage directed to an individual active light source 224 in the operational power state. As would be understood, the reduction in power or voltage may be achieved by reducing continuous output to the light source 224 (e.g., as a lower percentage of potential output, reduced pulse-width modulation, or as a lowered duty cycle).

Turning briefly to FIG. 7, a deviated illumination at a reduced brightness level is illustrated. As shown, a sub-portion of light sources 224 of the panel set 222 may be directed to an active state (e.g., at a reduced duty cycle of 12 Volts) while the remaining light sources 224 of the panel set 222 are directed or held at an inactive state. Moreover, the sub-portion is an odd and unevenly distributed number of light sources 224. Thus, and as further illustrated in FIG. 6, the resulting illumination of the static image region 232 may be non-uniform. Notably, the contrast in illumination may permit a user to see the static image region 232 while efficiently communicating that the user interface 200 is in the low-power state. Additionally or alternatively, total power draw of the user interface 200 may be significantly reduced (e.g., in comparison to the wake state or uniform illumination of the static image region 232).

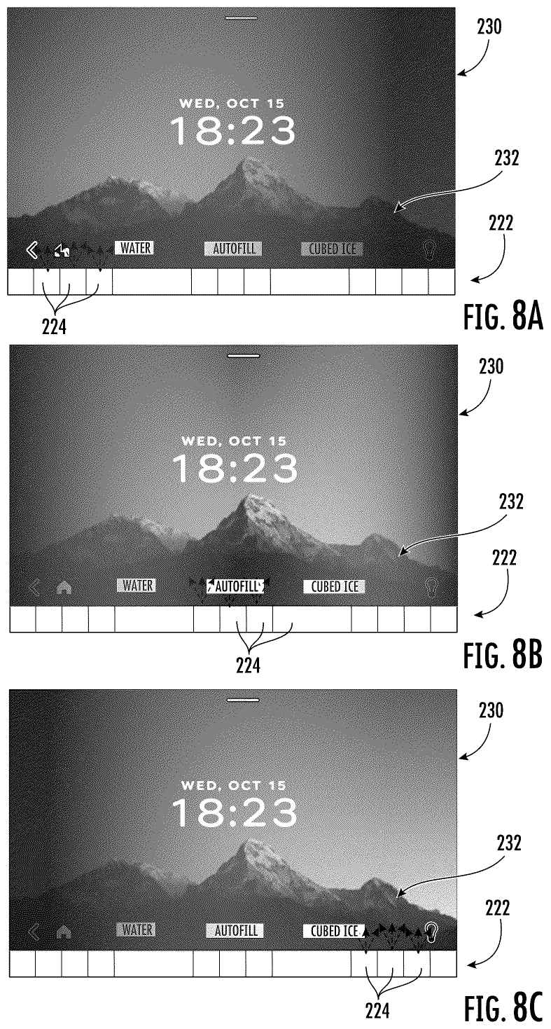

Turning now to FIGS. 8A, 8B, and 8C, in optional embodiments, the low-power state may provide for at least some variation in the illumination. For instance, although the static image region 232 may remain generally constant, the specific light sources 224 that are active from the panel set 222 may be adjusted, changed, or otherwise varied (e.g., according to a variable low-power scheme or pattern). For instance, one or more variation triggers may be provided to, when detected, prompt one or more predetermined variations. In the illustrated embodiments, different sub-portions of the panel set 222 are illuminated at different points in time of the day. As an example, in response to determining a first time window (e.g., that a current time falls within the first time window, such as between a determined or programmed sunrise time and selected mid-morning time), a first sub-portion (FIG. 8A) may be illuminated. Additionally or alternatively, in response to determining a second time window (e.g., that a current time falls within the second time window, such as between the selected mid-morning time and a selected mid-afternoon time), a second sub-portion (FIG. 8B) may be illuminated. Further additionally or alternatively, in response to determining a third time window (e.g., that a current time falls within the third time window, such as between the selected mid-afternoon time and a determined or programmed sunset time), a third sub-portion (FIG. 8C) may be illuminated.

Although variation between multiple sub-portions is illustrated between FIGS. 8A, 8B, and 8C, additional or alternative embodiments may vary illumination at a single sub-portion (e.g., such that a single sub-portion is pulsed or alternately activated according to a programmed pattern), as would be understood in light of the present disclosure.

Turning now to FIG. 9, various methods may be provided for use with a consumer appliance (e.g., appliance 100) in accordance with the present disclosure. In general, the various steps of methods as disclosed herein may, in exemplary embodiments, be performed by the controller 150 part of a display operation that the controller 150 is configured to initiate. During such methods, controller 150 may receive inputs and transmit outputs from various other components of the appliance 100. For example, controller 150 may send signals to and receive signals from user interface 200, including light source(s) 224. In particular, the present disclosure is further directed to methods, as indicated by 900, for operating appliance 100. Such method may advantageously offer increased efficiency or a significantly lower power draw (e.g., in comparison to existing appliances or display panels) over the life thereof (e.g., without impairing overall visibility or usability). Additionally or alternatively, such methods may effectively communicate information regarding the status of the appliance (e.g., with greater speed or efficacy than is realized with methods).

It is noted that the order of steps within method 900 is for illustrative purposes. Except as otherwise indicated, one or more steps in the below method 900 may be changed, rearranged, performed in a different order, or otherwise modified without deviating from the scope of the present disclosure.

At 910, the method 900 includes directing illumination of a static image region of the LCD panel at an operational brightness level—e.g., a first brightness level corresponding to a predetermined brightness setting (e.g., in nits or lumens), voltage output, duty cycle, or number of total active light sources. The operational brightness level may be constant (e.g., for the duration of 910 or while the display panel remains in a wake state). Thus, 910 generally requires maintaining one or more light sources of the panel set in an active state wherein light is emitted from the light source and the brightness of the static image region does not perceptibly (e.g., visibly) change as it is viewed by a user. Moreover, the static image region may be illuminated substantially uniformly (i.e., in a uniform illumination condition) such that no “hot-spot” is perceptible (e.g., as described above). In other words, 910 may include directing uniform illumination across the panel. (e.g., an entirety of the visible region or static image region).

In some embodiments, 910 includes directing activation of an operational number of light sources (e.g., LEDs) of the total panel set (e.g., all or according to another uniform pattern, as described above). For instance, a constant supply voltage may be transmitted to the operational number of light sources according to a duty cycle having a programmed refresh rate and PWM percentage corresponding to the operational brightness level.

At 920, the method 900 includes detecting a low-power condition. Generally, such a low-power condition corresponds to a condition or state in which engagement of the display panel is unlikely to occur. Such conditions or states, and detection thereof, are generally understood. As an example, 920 may include determining expiration of a predetermined engagement-window interval without receiving an engagement signal. Thus, if after the start of 910 or reception of a first engagement signal, a user fails to engage with the appliance or display panel (e.g., a second engagement signal is not received) prior to the predetermined engagement-window expiring, the low-power condition may be detected. As an additional or alternative example, 920 may include determining a programmed time period has been reached. In some such embodiments, the programmed time period is an interval of time of day or night (e.g., sunset to sunrise), such that the low-power condition is initiated or maintained during the programmed time period (e.g., barring any intervening engagement). As an additional or alternative example, 920 may include determining a user absence, such as by failing to detect a user presence (e.g., via one or more presence-detection sensors, as is understood).

At 930, the method 900 includes directing deviated or non-uniform illumination of the static image region at a reduced brightness level for a low-power state (e.g., based on or in response to 920). From the deviated illumination, a user may visually perceive that one portion of the visible region or static image region is dimmer than another portion. Separately or in addition, the overall visible region or display panel may be dimmed to the reduced brightness level—e.g., a second brightness level corresponding to a predetermined brightness setting (e.g., in nits or lumens), voltage output, duty cycle, or number of total active light sources that is less than the operational brightness level of 910.

In some embodiments, the reduced brightness level is obtained, at least in part, by reducing the number of light sources that are active or illuminated (e.g., in comparison to the operational number). For instance, 930 may include wherein directing activation of a reduced number of light sources (e.g., LEDs) of the total panel set. As suggested, the reduced number of light sources may be less than the operational number of 910 such that fewer light sources of the panel set are active at the reduced brightness level than the operational brightness level. Additionally or alternatively, the reduced brightness level may be obtained by reducing the brightness level (e.g., predetermined brightness setting (e.g., in nits or lumens), voltage output, or duty cycle) of each active light source.

In optional embodiments, the dimming of the panel set to the reduced brightness level may be gradual. Specifically, 930 may include directing a gradual brightness reduction from the operational brightness level to the reduced brightness level. In certain embodiments, the reduction of the brightness level is linear (e.g., from the operational brightness level at 910 to the reduced brightness level). Thus, the fading or dimming of the light sources or panel set may appear to occur at a constant (e.g., predetermined, programmed) rate, advantageously preventing the impression of sluggishness or error.

In some embodiments, 930 includes transmitting a plurality of sequentially-decreasing brightness-level signals to the light sources or panel set. For instance, 3 or more sequentially-decreasing brightness-level signals may be transmitted at a set rate (e.g., a 99% PWM signal, a 66% PWM signal, and a 33% PWM signal transmitted at sequential 30 millisecond intervals). Thus, the brightness level of the light sources or panel set may be sequentially-decreased. As described above, each sequential brightness-level signal may decrease the PWM percentage. Thus, 930 may include reducing a PWM of power to a light source of the panel set.

The reduction from the operational brightness level at 910 to reduced brightness level may be set to occur over a preset fade timespan less than or equal to a maximum value (e.g., 5 seconds, 2 seconds, 1 second, 0.5 seconds), but greater than or equal to a minimum value (e.g., 0.05 seconds, 0.1 seconds, 0.2 seconds). For instance, the reduction from 310 to 0 may be set to a preset fade timespan less than or equal to 2 seconds and greater than or equal to 0.05 seconds, although any other exemplary maximum/minimum may be considered within the scope of the present disclosure.

In certain embodiments, directing the gradual brightness reduction includes reducing voltage at the light sources or panel set. For instance, the voltage may be reduced according to sequential steps or signals, as described above. Alternatively, the voltage may be decayed naturally. As an example, a transmitted supply voltage to the light sources or panel set may be temporarily stored, then decreased at a decaying rate from a capacitor once the controller issues a signal to halt transmission of the supply voltage. Thus, 930 may include decaying a transmitted voltage through a capacitor in electrical communication with a light source of the light sources or panel set.

In optional embodiments, 930 includes varying activation of two or more light sources (e.g., LEDs) of the panel set according to a variable low-power scheme during the low-power state. For instance, although the static image region may remain generally constant, the specific light sources that are active from the panel set may be adjusted, changed, or otherwise varied (e.g., according to a predetermined pattern or sequence programmed with the low-power scheme). As noted above, a variable low-power scheme comprises a variation trigger, and wherein the method comprises detecting a variation-trigger event to prompt varying activation of the two or more light sources (e.g., between different light sources or sub-portions of the panel set or, alternatively, at a single light source or sub-portion of the panel set). Optionally, one or more variation triggers may be provided to, when detected, prompt one or more predetermined variations. As described above, different sub-portions of the panel set may be illuminated at different points in time of the day (e.g., having time window variation triggers) as part of the variable low-power scheme. Additionally or alternatively, different variation triggers; such as one or more alerts, modes, or detected events determined by the appliance—as are generally understood.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a liquid crystal display (LCD) panel of a consumer appliance, the method comprising:
directing illumination of a static image region of the LCD panel at an operational brightness level;
detecting a low-power condition; and
directing deviated illumination of the static image region at a reduced brightness level for a low-power state based on the detected low-power condition.

2. The method of claim 1, wherein directing illumination of the static image region of the LCD panel at the operational brightness level comprises directing uniform illumination across the LCD panel.

3. The method of claim 1, wherein directing illumination of the static image region of the LCD panel at the operational brightness level comprises directing illumination of each light source of the LCD panel.

4. The method of claim 1, wherein the LCD panel comprises a total panel set of a plurality of light emitting diodes (LEDs),
wherein directing illumination of the static image region of the LCD panel at the operational brightness level comprises directing activation of an operational number of LEDs of the total panel set, and
wherein directing deviated illumination of the static image region at the reduced brightness level comprises directing activation of a reduced number of LEDs of the total panel set, the reduced number of LEDs being less than the operational number such that fewer LEDs of the LCD panel set are active at the reduced brightness level than the operational brightness level.

5. The method of claim 1, wherein directing deviated illumination of the static image region at the reduced brightness level comprises directing a gradual brightness reduction from the operational brightness level to the reduced brightness level.

6. The method of claim 5, wherein directing the gradual brightness reduction comprises transmitting a plurality of sequentially-decreasing brightness-level signals to a panel set of light sources of the LCD panel.

7. The method of claim 5, wherein directing the gradual brightness reduction comprises reducing voltage at a panel set of light sources of the LCD panel.

8. The method of claim 1, wherein the LCD panel comprises a total panel set of a plurality of light emitting diodes (LEDs),
wherein directing deviated illumination of the static image region at the reduced brightness level comprises varying activation of two or more LEDs of the panel set according to a variable low-power scheme during the low-power state.

9. The method of claim 8, wherein the variable low-power scheme comprises a variation trigger, and wherein the method comprises detecting a variation-trigger event to prompt varying activation of the two or more LEDs.

10. An appliance user interface panel of a consumer appliance comprising:
a liquid crystal display (LCD) panel mounted on a body panel of the consumer appliance, the LCD panel comprising a panel set of light sources; and
a controller operably coupled to the panel set, the controller being configured to initiate a display operation, the display operation comprising
directing illumination of a static image region of the LCD panel at an operational brightness level,
detecting a low-power condition, and
directing deviated illumination of the static image region at a reduced brightness level for a low-power state based on the detected low-power condition.

11. The appliance user interface panel of claim 10, wherein directing illumination of the static image region of the LCD panel at the operational brightness level comprises directing uniform illumination across the panel.

12. The appliance user interface panel of claim 10, wherein directing illumination of the static image region of the LCD panel at the operational brightness level comprises directing illumination of each light source of the LCD panel.

13. The appliance user interface panel of claim 10, wherein the LCD panel comprises a total panel set of a plurality of light emitting diodes (LEDs),
wherein directing illumination of the static image region of the LCD panel at the operational brightness level comprises directing activation of an operational number of LEDs of the total panel set, and
wherein directing deviated illumination of the static image region at the reduced brightness level comprises directing activation of a reduced number of LEDs of the total panel set, the reduced number of LEDs being less than the operational number such that fewer LEDs of the panel set are active at the reduced brightness level than the operational brightness level.

14. The appliance user interface panel of claim 10, wherein directing deviated illumination of the static image region at the reduced brightness level comprises directing a gradual brightness reduction from the operational brightness level to the reduced brightness level.

15. The appliance user interface panel of claim 14, wherein directing the gradual brightness reduction comprises transmitting a plurality of sequentially-decreasing brightness-level signals to a panel set of light sources of the LCD panel.

16. The appliance user interface panel of claim 14, wherein directing the gradual brightness reduction comprises reducing voltage at a panel set of light sources of the LCD panel.

17. The appliance user interface panel of claim 10, wherein the LCD panel comprises a total panel set of a plurality of light emitting diodes (LEDs),
wherein directing deviated illumination of the static image region at the reduced brightness level comprises varying activation of two or more LEDs of the panel set according to a variable low-power scheme during the low-power state.

18. The appliance user interface panel of claim 17, wherein the variable low-power scheme comprises a variation trigger, and wherein the display operation further comprises detecting a variation-trigger event to prompt varying activation of the two or more LEDs.
